(19) United States
(12) Patent Application Publication
(10) Pub. No.: US 2026/0290703 A1
(43) Pub. Date: Sep. 24, 2026

(54) MULTILAYER ELECTRONIC DEVICE AND METHOD OF MANUFACTURING THE SAME

(71) Applicant: TDK Corporation, Tokyo (JP)

(72) Inventors: Asuka MURAKAMI, Tokyo (JP); Masahide ISHIZUYA, Tokyo (JP); Toshio SAKURAI, Tokyo (JP); Makoto ISHIZAKI, Tokyo (JP); Yuki OKAFUJI, Tokyo (JP); Noriyuki INOUE, Tokyo (JP)

(73) Assignee: TDK Corporation, Tokyo (JP)

(21) Appl. No.: 19/570,304

(22) Filed: Mar. 18, 2026

(30) Foreign Application Priority Data
Mar. 19, 2025 (JP) 2025-045518

(51) Int. Cl. H01G 4/30; H01G 4/012

(52) U.S. Cl. CPC H01G 4/30; H01G 4/012

(57) ABSTRACT

A multilayer electronic device includes an element body including internal electrode layers and dielectric layers, which are alternately laminated along a direction of a third axis and are substantially parallel to a plane containing a first axis and a second axis. The element body includes side surfaces in pairs provided with respective insulating layers. The side surfaces face each other in a direction of the first axis. The element body includes end surfaces in pairs with respective external electrodes electrically connected to the internal electrode layers. The end surfaces face each other in a direction of the second axis. At least some of the internal electrode layers adjacent to each other in the direction of the third axis have grooves at respective boundaries between the at least some of the internal electrode layers and the insulating layers. The grooves are aligned along the direction of the third axis.

### TECHNICAL FIELD

The present invention relates to a multilayer electronic device and a method of manufacturing the same.

Demand for downsizing electronic devices has been increasing along with a recent increase in the density of electronic circuits included in digital electronics (e.g., mobile phones). Constituent multilayer electronic devices of these circuits have rapidly been reduced in size and increased in capacity.

Patent Document 1 discloses a method of manufacturing a multilayer ceramic capacitor. The method includes a step of printing internal electrodes continuing in a longitudinal direction in strips on molded continuous dielectric sheets, a step of continuously laminating the dielectric sheets with the printed internal electrodes and continuous dielectric sheets without printed internal electrodes, a step of cutting the resultant continuous laminate into pieces and then forming insulating layers at portions where no external electrodes are to be provided among exposed portions of the internal electrodes, and a step of forming external electrodes at the exposed portions of the internal electrodes.

However, the multilayer ceramic capacitor disclosed in Patent Document 1 unfortunately has insufficient adhesion between the insulating layers and the laminate. This problem may generate pores between the insulating layers and the laminate, increasing manufacturing defects or bringing a lack of reliability. More specifically, moisture or the like used in a manufacturing step of forming the external electrodes by plating may enter the pores between the insulating layers and the laminate to cause manufacturing defects or reduction in reliability.
Patent Document 1: JP Patent Application Laid Open No. S62-237714

### SUMMARY

The present disclosure has been achieved in view of the above circumstances and aims to provide a multilayer electronic device that has improved adhesion between an element body and insulating layers and can prevent generation of a pore between the insulating layers and the laminate.

To achieve the above object, a multilayer electronic device according to the present disclosure is as follows.

The multilayer electronic device includes
an element body including internal electrode layers and dielectric layers, the internal electrode layers and the dielectric layers being alternately laminated along a direction of a third axis and being substantially parallel to a plane containing a first axis and a second axis,
wherein
the element body includes side surfaces in pairs provided with respective insulating layers, the side surfaces facing each other in a direction of the first axis;
the element body includes end surfaces in pairs provided with respective external electrodes electrically connected to the internal electrode layers, the end surfaces facing each other in a direction of the second axis;
at least some of the internal electrode layers adjacent to each other in the direction of the third axis have grooves at respective boundaries between the at least some of the internal electrode layers and the insulating layers; and
the grooves are aligned along the direction of the third axis.

Such a multilayer electronic device has the grooves at the boundaries between the internal electrode layers and the insulating layers, and these grooves of some of the internal electrode layers adjacent to each other in the lamination direction are aligned along the lamination direction. This enables the internal electrode layers and the insulating layers to engage with each other at the boundaries to increase adhesion between the side surfaces of the element body and the insulating layers. This can prevent generation of pores between the insulating layers and the laminate. Prevention of generation of pores between the insulating layers and the laminate can prevent manufacturing defects and improve reliability.

Examples of specific forms of the above include the following.

The grooves may have, for example, a depth of 0.1 μm or more and 5 μm or less.

The predetermined range of the depth of the grooves can increase adhesion between the side surfaces of the element body and the insulating layers and prevent reduction in capacitance due to excessive reduction in the electrode facing area.

A method of manufacturing a multilayer electronic device, according to the present disclosure includes
laminating and then cutting dielectric green sheets and internal electrode pattern layers to provide a green laminate including the dielectric green sheets and the internal electrode pattern layers alternately laminated;
irradiating a laminate side surface of the green laminate with a laser for laser processing of the internal electrode pattern layers included in the green laminate, the laminate side surface including at least one cut surface of the green laminate;

forming an insulating material layer on the laminate side surface of the green laminate after the laser processing; and
firing the green laminate with the insulating material layer,
wherein
the laser processing is performed so that grooves are formed at respective exposed portions of at least some of the internal electrode pattern layers adjacent to each other in a lamination direction and are aligned along the lamination direction, and
the exposed portions are exposed to the laminate side surface.

According to such a method of manufacturing a multilayer electronic device, the side surface of the green laminate is laser processed to form the grooves of the internal electrode pattern layers. Then, the insulating material layer is formed on this side surface. This improves adhesion between the green laminate and the insulating material layer. Thus, according to such a method of manufacture, adhesion between the green laminate and the insulating material layer before firing and adhesion between the element body and the insulating layer after firing are improved. This can prevent generation of pores between the green laminate and the insulating material layer and between the element body and the insulating layer. Moreover, such a method of manufacture can prevent manufacturing defects and improve reliability of the manufactured multilayer electronic device.

### BRIEF DESCRIPTION OF THE DRAWING(S)

FIG. 1 is a schematic sectional view of a multilayer ceramic capacitor, which is a multilayer electronic device, according to one embodiment of the present disclosure.

FIG. 2 is a schematic perspective view of an element body and insulating layers of the multilayer ceramic capacitor illustrated in FIG. 1.

FIG. 3 is a schematic sectional view along a line III-III in FIG. 2.

FIG. 4 is a schematic sectional view along a line IV-IV in FIG. 2.

FIG. 5 is a schematic sectional view of internal electrode layers of the multilayer ceramic capacitor illustrated in FIG. 2.

FIG. 6 is a cross-sectional view of a multilayer ceramic capacitor according to a modified example.

FIG. 7 is a longitudinal sectional view of the multilayer ceramic capacitor according to the modified example.

FIG. 8 is a schematic view of a green laminate of a method of manufacturing the multilayer ceramic capacitor illustrated in FIG. 1.

FIG. 9 is a schematic view of a laminating/cutting step of the method of manufacturing the multilayer ceramic capacitor illustrated in FIG. 1.

FIG. 10 is a schematic view of a laser processing step of the method of manufacturing the multilayer ceramic capacitor illustrated in FIG. 1.

### DETAILED DESCRIPTION

Detailed description is provided based on the present embodiment with reference to the drawings; however, the present disclosure is not construed as limited only to the following embodiment.

Constituents described below include those that a person skilled in the art can easily conceive of or those that are substantially the same. Furthermore, the constituents described below can be recombined appropriately.

Hereinafter, the present disclosure is described based on the embodiment illustrated in the drawings.

As one embodiment of a multilayer electronic device according to the present embodiment, an overall configuration of a multilayer ceramic capacitor 10 is described.

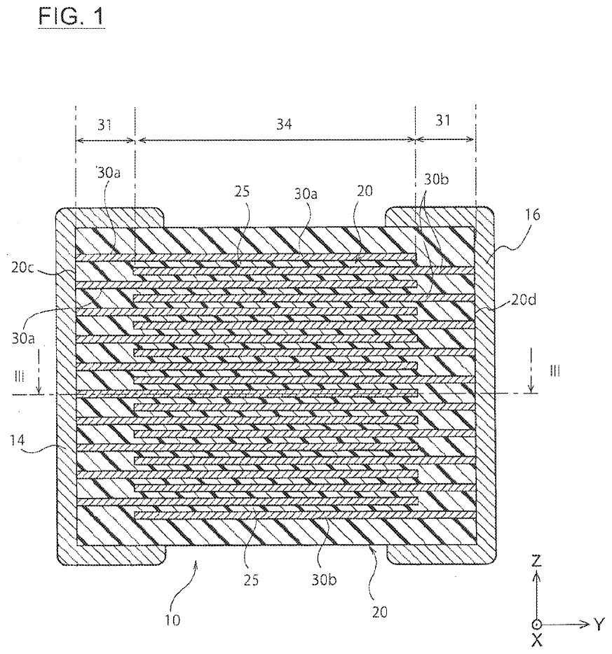

FIG. 1 is a schematic sectional view of the multilayer ceramic capacitor 10 according to the present embodiment. As illustrated in FIG. 1, the multilayer ceramic capacitor 10 includes an element body 20, where internal electrode layers 30 and dielectric layers 25, which are substantially parallel to a plane containing the X-axis as a first axis and the Y-axis as a second axis, are alternately laminated along the Z-axis as a third axis.

In this context, “substantially parallel” means that the internal electrode layers 30 and the dielectric layers 25 are mostly parallel to the plane but may partly be slightly nonparallel. This intends to convey that the internal electrode layers 30 and the dielectric layers 25 may be slightly uneven or inclined.

As illustrated in FIG. 1, end surfaces 20c and 20d of the element body 20 in pairs, which face each other in the second axis (Y-axis) direction, are provided with external electrodes 14 and 16, which electrically connect to the internal electrode layers 30, respectively. That is, the internal electrode layers 30 include first internal electrode layers 30a, which connect to the external electrode 14 on the end surface 20c, and second internal electrode layers 30b, which connect to the external electrode 16 on the end surface 20d. The first internal electrode layers 30a and the second internal electrode layers 30b are alternately laminated along the third axis (Z-axis), with the dielectric layers 25 in between.

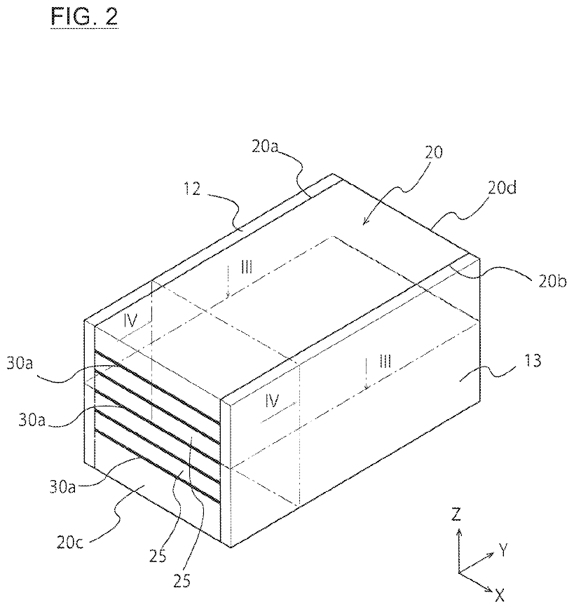

FIG. 2 is a schematic perspective view of the element body 20 and insulating layers 12 and 13 of the multilayer ceramic capacitor 10 illustrated in FIG. 1. FIG. 2 does not illustrate the external electrodes 14 and 16 (see FIG. 1) of the multilayer ceramic capacitor 10 in order to illustrate the end surface 20c of the element body 20. Note that, in FIGS. 1 and 2, the internal electrode layers 30 are illustrated to have a larger thickness (dimension in the Z-axis direction) than the actual dimension, and the internal electrode layers 30 and the dielectric layers 25 are simply and schematically illustrated to be fewer in number. The numbers of the internal electrode layers 30 and the dielectric layers 25 and the thickness of the internal electrode layers 30 are not limited.

As illustrated in FIG. 2, side surfaces 20a and 20b of the element body 20 in pairs, which face each other in the first axis (X-axis) direction, are provided with the insulating layers 12 and 13, respectively. The side surface 20a in the negative direction of the X-axis is provided with the insulating layer 12. The side surface 20b in the positive direction of the X-axis is provided with the insulating layer 13.

As illustrated in FIG. 1, the internal electrode layers 30 include an internal electrode overlapping portion 34 and internal electrode lead-out portions 31. The internal electrode overlapping portion 34 is where the first internal electrode layers 30a, which are drawn out to the end surface 20c of the pair of end surfaces 20c and 20d, and the second internal electrode layers 30b, which are drawn out to the end surface 20d of the pair, overlap when viewed from the Z-axis direction (third axis direction). The internal electrode lead-out portions 31 are where the first internal electrode layers 30a and the second internal electrode layers 30b do not overlap when viewed from the Z-axis direction (third axis direction).

As illustrated in FIG. 1, in the element body 20, the internal electrode overlapping portion 34 is disposed so as to be interposed between the internal electrode lead-out portions 31 in pairs from both sides in the Y-axis (second axis) direction. In other words, from the end surface 20c to the end surface 20d of the element body 20 along the second axis (Y-axis) direction, the internal electrode lead-out portion 31, the internal electrode overlapping portion 34, and the internal electrode lead-out portion 31 are disposed in sequence. The internal electrode lead-out portion 31 close to the end surface 20c is part of the first internal electrode layers 30a. The internal electrode lead-out portion 31 close to the end surface 20d is part of the second internal electrode layers 30b. The internal electrode overlapping portion 34 includes other part of the first internal electrode layers 30a and other part of the second internal electrode layers 30b.

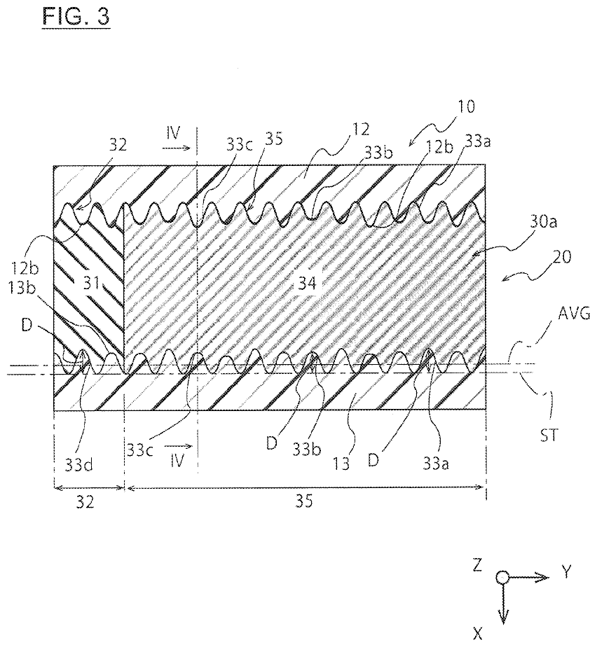

FIG. 3 is a sectional view along a line III-III in FIG. 2. That is, FIG. 3 is a schematic view of one first internal electrode layer 30a, which is one of the internal electrode layers 30 included in the element body 20, and the insulating layers 12 and 13 in a section that passes a center of the first internal electrode layer 30a in the third axis (Z-axis) direction and is parallel to the first axis and the second axis (X-axis and Y-axis).

As illustrated in FIG. 3, the first internal electrode layer 30a, which is one of the internal electrode layers 30 included in the element body, is interposed between the insulating layers 12 and 13 from both sides in the first axis (X-axis) direction. The first internal electrode layer 30a includes the internal electrode lead-out portion 31 close to the end surface 20c of the element body 20 and the internal electrode overlapping portion 34 more to a central side in the Y-axis direction relative to the internal electrode lead-out portion 31.

An end of the internal electrode lead-out portion 31 in the negative direction of the Y-axis is exposed to the end surface 20c of the element body 20. An end of the internal electrode lead-out portion 31 in the positive direction of the Y-axis connects to the internal electrode overlapping portion 34. An end of the internal electrode overlapping portion 34 in the negative direction of the Y-axis connects to the internal electrode lead-out portion 31. An end of the internal electrode overlapping portion 34 in the positive direction of the Y-axis connects to the dielectric layer 25. Thus, the end of the internal electrode overlapping portion 34 in the positive direction of the Y-axis is not exposed to the end surface 20d of the element body 20.

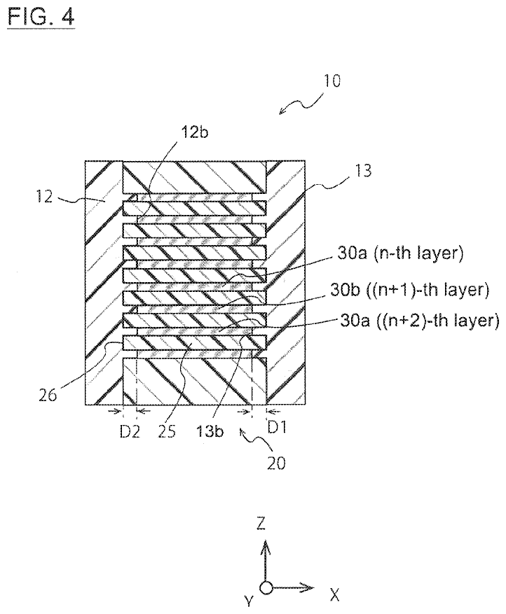

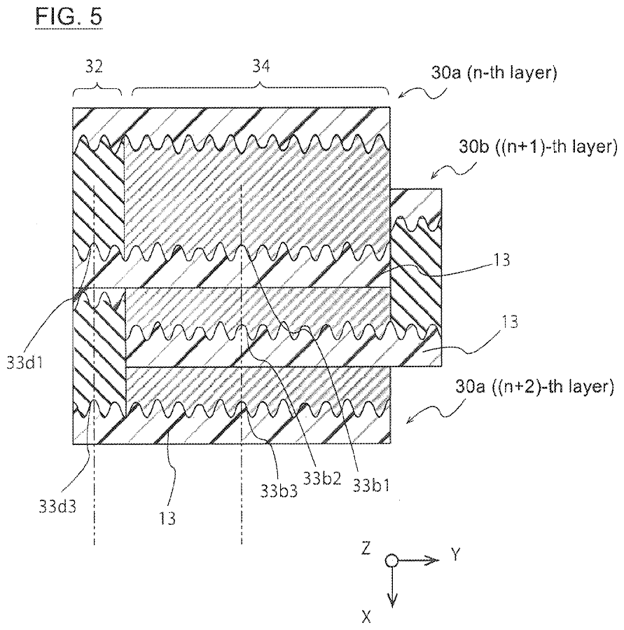

As illustrated in FIG. 3, the first internal electrode layer 30a has grooves 33a, 33b, 33c, and 33d at its side edges (lead-out portion side edges 32 and overlapping portion side edges 35) in the X-axis direction. The side edges are boundaries between the first internal electrode layer 30a and the insulating layers 12 and 13. As described later with reference to FIGS. 4 and 5, other internal electrode layers 30 included in the multilayer ceramic capacitor 10 have grooves similar to the grooves 33a, 33b, 33c, and 33d, similarly to the first internal electrode layer 30a illustrated in FIG. 3.

The first internal electrode layer 30a has the grooves 33a, 33b, 33c, and 33d at both the side edges in the negative direction of the X-axis, which are the boundaries between the first internal electrode layer 30a and the insulating layer 12, and the side edges in the positive direction of the X-axis, which are the boundaries between the first internal electrode layer 30a and the insulating layer 13. Such grooves 33a, 33b, 33c, and 33d can improve adhesion with the insulating layers 12 and 13 at both sides.

As illustrated in FIG. 3, the lead-out portion side edges 32 and the overlapping portion side edges 35 of the first internal electrode layer 30a have the grooves 33a, 33b, 33c, and 33d continuously and regularly along the Y-axis direction. Such continuous and regular grooves 33a, 33b, 33c, and 33d can improve adhesion between the insulating layers 12 and 13 and the element body 20 not locally but entirely, effectively preventing generation of pores.

However, the lead-out portion side edges 32 and the overlapping portion side edges 35 of the first internal electrode layer 30a may have the grooves 33a, 33b, 33c, and 33d intermittently or discretely along the Y-axis direction. In this situation, preferred is that the grooves 33a, 33b, 33c, and 33d of the first internal electrode layer 30a include both the grooves 33a, 33b, and 33c at the overlapping portion side edges 35 and the groove 33d at the lead-out portion side edges 32. Note that grooves of the first internal electrode layer 30a include those without denotation by reference numerals (33a, 33b, 33c, and 33d) as illustrated in FIG. 3; however, in this embodiment, description is provided with the example of the grooves 33a, 33b, 33c, and 33d.

Preferred is that each of the grooves 33a, 33b, 33c, and 33d has a depth D of 0.1 μm or more and 5 μm or less in terms of improving adhesion between the insulating layers 12 and 13 and the element body 20 and preventing reduction in the electrode facing area due to excessive depth of the grooves. The depth D of each of the grooves 33a, 33b, 33c, and 33d of the side edges in the positive direction of the X-axis is defined by the distance, along the X-axis direction, between a standard line ST, which passes a most protruding location of the first internal electrode layer 30a in the positive direction of the X-axis and extends parallel to the Y-axis direction, and a bottom of each of the grooves 33a, 33b, 33c, and 33d. Similarly, the depth D of each of the grooves 33a, 33b, 33c, and 33d of the side edges in the negative direction of the X-axis is defined by the distance, along the X-axis direction, between a standard line ST, which passes a most protruding location of the first internal electrode layer 30a in the negative direction of the X-axis and extends parallel to the Y-axis direction, and a bottom of each of the grooves 33a, 33b, 33c, and 33d.

The bottom of each of the grooves 33a, 33b, 33c, and 33d is at a location farthest from the standard line ST. In a situation where the grooves of the lead-out portion side edges 32 or the overlapping portion side edges 35 include portions that are distanced in the Y-axis direction over an average distance line AVG, which is a line indicating an average distance from the standard line ST of the lead-out portion side edges 32 or the overlapping portion side edges 35, the grooves are deemed to be separate grooves.

The number of grooves of the lead-out portion side edges 32 and the overlapping portion side edges 35, which are the boundaries between the first internal electrode layer 30a and the insulating layers 12 and 13, and the distances between the grooves in the Y-axis direction are not limited. As one example, the number of the grooves can be 10 to 100, and the distances in the Y-axis direction can be 1.0 to 5.0 μm.

As illustrated in FIG. 3, the insulating layers 12 and 13 include insulating layer irregular portions 12b and 13b, which engage with the grooves 33a, 33b, 33c, and 33d of the first internal electrode layer 30a. Engagement of the insulating layer irregular portions 12b and 13b with the grooves 33a, 33b, 33c, and 33d of the first internal electrode layer 30a can improve adhesion between the element body 20 and the insulating layers 12 and 13, effectively preventing generation of pores between the insulating layers 12 and 13 and the side surfaces 20a and 20b of the element body 20. Although not illustrated in FIG. 3, the second internal electrode layers 30b also have grooves at their side edges (lead-out portion side edges 32 and overlapping portion side edges 35) in the X-axis direction, which are boundaries between the second internal electrode layers 30b and the insulating layers 12 and 13, similarly to the first internal electrode layer 30a illustrated in FIG. 3.

FIG. 4 is a sectional view along a line IV-IV in FIG. 2. That is, FIG. 4 is a schematic sectional view of the element body 20 cut parallel to the X-axis (first axis) and the Z-axis (third axis). As illustrated in FIG. 4, the grooves 33c are aligned along the third axis (Z-axis) direction, which is the lamination direction of the internal electrode layers 30 and the dielectric layers 25. Thus, in the section parallel to the X-axis direction and the Z-axis direction illustrated in FIG. 4, the grooves 33c between the first internal electrode layers 30a and the second internal electrode layers 30b and the insulating layer 13 have substantially the same depth D1.

In FIG. 4, the grooves 33c between the first internal electrode layers 30a and the second internal electrode layers 30b and the insulating layer 12 have substantially the same depth D2, similarly to the grooves 33c between the first internal electrode layers 30a and the second internal electrode layers 30b and the insulating layer 13. Note that, although the depths D1 and D2 substantially match in FIG. 4, the depths D1 and D2 may differ from each other.

FIG. 5 is a schematic view of shapes of boundaries between the insulating layers 12 and 13 and some (three in the illustration) of the internal electrode layers 30 adjacent to each other in the third axis (Z-axis) direction, which is the lamination direction. These internal electrode layers 30 are one first internal electrode layer 30a (n-th layer), one second internal electrode layer 30b ((n+1)-th layer), and one first internal electrode layer 30a ((n+2)-th layer). FIG. 5 illustrates grooves 33b1 and 33d1 of the first internal electrode layer 30a (n-th layer), a groove 33b2 of the second internal electrode layer 30b ((n+1)-th layer), and grooves 33b3 and 33d3 of the first internal electrode layer 30a ((n+2)-th layer), offset in the X-axis direction but not in the Y-axis direction for overlap. The first internal electrode layer 30a (n-th layer), the second internal electrode layer 30b ((n+1)-th layer), and the first internal electrode layer 30a ((n+2)-th layer) in FIG. 5 correspond to the first internal electrode layer 30a (n-th layer), the second internal electrode layer 30b ((n+1)-th layer), and the first internal electrode layer 30a ((n+2)-th layer) in FIG. 4.

As illustrated in FIG. 5, the respective grooves 33b1, 33b2, and 33b3 of the internal electrode layers (three in the illustration) adjacent to each other in the third axis (Z-axis) direction or the lamination direction, namely the first internal electrode layer 30a (n-th layer), the second internal electrode layer 30b ((n+1)-th layer), and the first internal electrode layer 30a ((n+2)-th layer), are at substantially the same Y-axial location, being aligned along the third axis (Z-axis) direction. Note that the grooves 33b1, 33b2, and 33b3 are at the overlapping portion side edge 35 (see FIG. 3) of the internal electrode overlapping portion 34.

In contrast, as illustrated in FIG. 5, at the lead-out portion side edge 32 of the internal electrode lead-out portion 31, only the first internal electrode layers 30a are laminated in the Z-axis direction. Similarly to the overlapping portion side edge 35, at the lead-out portion side edge 32 as well, the respective grooves 33dl and 33d3 of the internal electrode layers (two in the illustration) adjacent to each other in the third axis (Z-axis) direction or the lamination direction, namely the first internal electrode layer 30a (n-th layer) and the first internal electrode layer 30a ((n+2)-th layer), are at substantially the same Y-axial location, being aligned along the third axis (Z-axis) direction.

In this context, that the grooves 33b1, 33b2, and 33b3 are aligned along the third axis (Z-axis) direction can be defined as the bottoms of the grooves 33b1, 33b2, and 33b3 being Y-axially located with a 4-μm difference at most (or being located away by +2 μm or less from a reference point). Such an alignment of the grooves 33b1, 33b2, and 33b3 along the lamination direction (Z-axis direction) enables the side surfaces 20a and 20b of the element body 20 and the insulating layers 12 and 13 provided there to engage with each other, increasing adhesion between the side surfaces 20a and 20b of the element body 20 and the insulating layers 12 and 13. In contrast, if the grooves 33b1, 33b2, and 33b3 are not aligned along the third axis (Z-axis) direction, the effect of increasing adhesion between the side surfaces 20a and 20b of the element body 20 and the insulating layers 12 and 13 cannot be sufficiently exhibited. The same applies to the grooves 33d1 and 33d3.

The grooves 33b1, 33b2, and 33b3 of at least some adjacent layers are aligned along the third axis (Z-axis) direction; however, preferred is that the grooves of three or more internal electrode layers 30 adjacent to each other in the lamination direction are aligned along the direction. In terms of further increasing adhesion between the side surfaces 20a and 20b of the element body 20 and the insulating layers 12 and 13, the grooves 33b1, 33b2, 33b3, 33d1, and 33d3 of the lead-out portion side edges 32 or the overlapping portion side edges 35 of preferably 50% or more or more preferably 80% or more of the total number of adjacent layers of the element body 20 as a whole may be aligned along the third axis (Z-axis) direction.

As illustrated in FIG. 4, boundaries between the dielectric layers 25, which are disposed between the first internal electrode layers 30a and the second internal electrode layers 30b, and the insulating layers 12 and 13 have no grooves such as those of the first internal electrode layer 30a illustrated in FIG. 3. However, these boundaries (dielectric layer side edges 26) between the dielectric layers 25 and the insulating layers 12 and 13 may have dielectric layer grooves at Y-axial locations corresponding to the grooves 33a, 33b, 33c, and 33d of the internal electrode layers 30a and 30b. In this situation, the dielectric layer grooves of the dielectric layer side edges 26 may have a depth equivalent to or shallower than that of the grooves 33a, 33b, 33c, and 33d of the internal electrode layers 30a and 30b.

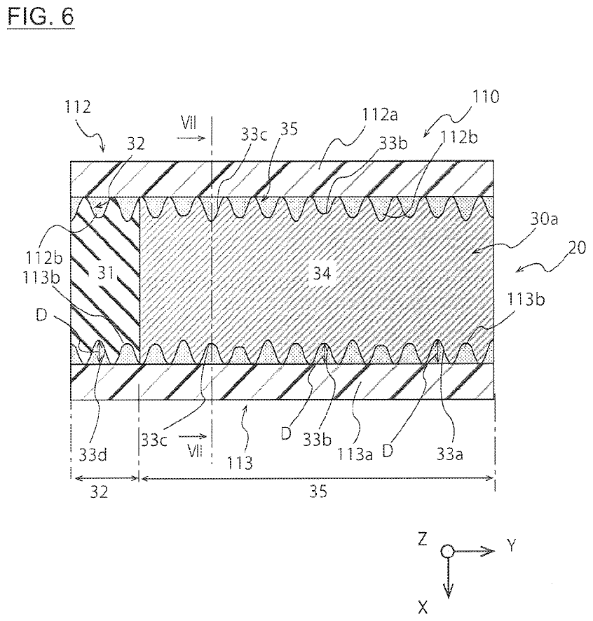

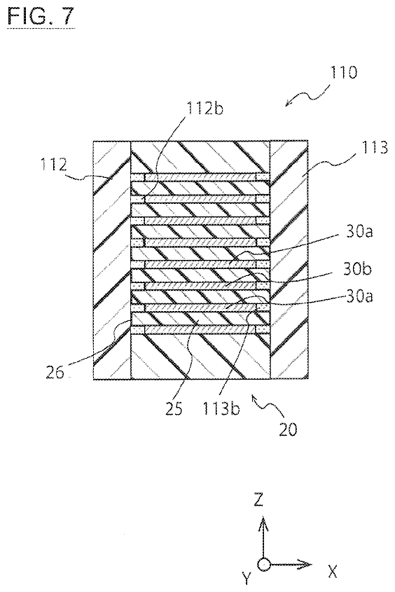

FIGS. 6 and 7 are sectional views of a multilayer ceramic capacitor 110 according to a modified example. FIG. 6 is a schematic view of a first internal electrode layer 30a of an element body 20 and insulating layers 112 and 113 in a section parallel to the first axis and the second axis (X-axis and Y-axis). FIG. 7 is a schematic sectional view of the element body 20 cut parallel to the X-axis (first axis) and the Z-axis (third axis).

As illustrated in FIG. 6, the multilayer ceramic capacitor 110 is different from the multilayer ceramic capacitor 10 illustrated in FIG. 3 and the like in that the insulating layers 112 and 113 on respective side surfaces 20a and 20b of the element body 20 of the multilayer ceramic capacitor 110 include insulating layer main portions 112a and 113a and insulating layer filler portions 112b and 113b. However, in other respects, the multilayer ceramic capacitor 110 is similar to the multilayer ceramic capacitor 10.

As illustrated in FIG. 7, the insulating layer main portions 112a and 113a of the insulating layers 112 and 113 have a substantially rectangular sectional shape. The insulating layer main portions 112a and 113a are provided by, for example, firing ceramic green sheets or the like. In contrast, the insulating layer filler portions 112b and 113b protrude from the insulating layer main portions 112a and 113a into grooves 33a, 33b, 33c, and 33d of the internal electrode layer 30a, filling irregularities defined by the grooves 33a, 33b, 33c, and 33d.

As is understandable from comparison between FIGS. 4 and 7, the insulating layer filler portions 112b and 113b of the multilayer ceramic capacitor 110 illustrated in FIG. 7 constitute portions corresponding to the insulating layer irregular portions 12b and 13b of the insulating layers 12 and 13 illustrated in FIG. 4. Constituent materials of the insulating layer filler portions 112b and 113b are not limited. Examples of main constituent materials of the insulating layer filler portions 112b and 113b include dielectric layers 25 of the element body 20 and a constituent insulating material of the insulating layer main portions 112a and 113a.

For example, 90% or more of the composition of the insulating layer filler portions 112b and 113b in mole percent may match the composition of the insulating layer main portions 112a and 113a or the dielectric layers 25. The insulating layer filler portions 112b and 113b can prevent thermal shrinkage behavior of a material near the insulating layer filler portions 112b and 113b to exhibit suitable adhesion, effectively preventing generation of pores.

Alternatively, for example, 20% or more of the composition of the insulating layer filler portions 112b and 113b in mole percent may differ from the composition of the insulating layer main portions 112a and 113a or the dielectric layers 25. Because there is a conductive material (e.g., the internal electrode layers 30) near the insulating layer filler portions 112b and 113b, a slight difference in the composition and the thermal shrinkage behavior from the insulating layer main portions 112a and 113a or the dielectric layers 25 can mitigate stress concentration, providing suitable adhesion.

Alternatively, for example, the insulating layer filler portions 112b and 113b may contain at least one selected from the group consisting of Mg, Si, and Mn, and the content of the at least one selected from the group consisting of Mg, Si, and Mn may be higher by 0.01 to 3 mol % than that of the dielectric layers 25. With such insulating layer filler portions 112b and 113b, crystal grain boundaries included in the insulating layer filler portions 112b and 113b can improve adhesion between the dielectric layers 25 and the insulating layer filler portions 112b and 113b.

Alternatively, for example, the insulating layer filler portions 112b and 113b may contain at least one selected from the group consisting of Mg, Si, and Mn and may contain an oxide of a metal identical to a metal contained in the internal electrode layers 30. Such insulating layer filler portions 112b and 113b have an effect of oxidizing part of the internal electrode layers 30 in contact with the insulating layer filler portions 112b and 113b, enabling improvement in adhesion between the insulating layer filler portions 112b and 113b and the internal electrode layers 30.

In the multilayer ceramic capacitors 10 and 110 illustrated in FIGS. 1 to 7, the dielectric layers 25 of the element body 20 may contain any constituent material. The material contains, for example, a dielectric material with a perovskite structure (e.g., ABO₃) or niobium oxide alkaline ceramic as a main component.

In ABO₃, for example, A includes at least one of Ca, Ba, Sr, and the like whereas B includes at least one of Ti, Zr, and the like. The molar ratio of A/B is not limited and is 0.980 to 1.020.

Other than the above, subcomponents may include silicon dioxide, aluminum oxide, alkaline earth metal compounds (e.g., magnesium oxide), manganese oxide, rare earth element oxide, and vanadium oxide but are not limited thereto. Their content is appropriately determined according to the composition or the like.

The internal electrode layers 30 illustrated in FIG. 1 may contain any conductive material. Metals, such as Ni, Cu, Ag, Pd, Al, and Pt, or their alloys can be used. Preferred as a Ni alloy is an alloy of Ni and at least one selected from the group consisting of Mn, Cr, Co, and Al. This alloy has a Ni content of preferably 95 wt % or more. Ni or the Ni alloy may contain approximately 0.1 wt % or less various trace components, such as P.

To form the internal electrode layers 30, a commercially available electrode paste may be used. The thickness of the internal electrode layers 30 is appropriately determined according to a use or the like.

The insulating layers 12 and 13 and the insulating layer main portions 112a and 113a can contain, for example, a dielectric material with a perovskite structure (e.g., ABO₃) or niobium oxide alkaline ceramic as a main component, similarly to the dielectric layers 25 of the element body 20. Alternatively, the insulating layers 12 and 13 and the insulating layer main portions 112a and 113a may contain glass as a main component.

Being composed of a glass component enables the insulating layers 12 and 13 and the insulating layer main portions 112a and 113a to have high bonding strength. It is assumed that this is because formation of a reaction phase at an interface between the glass and the element body 20 makes adhesion between the glass and the element body 20 superior to adhesion between other insulating materials and the element body 20.

The external electrodes 14 and 16 illustrated in FIG. 1 contain a known conductive material (e.g., Cu, Ni, Ag, Pd, Pt, Au, their alloys, and conductive resin). The thickness of the external electrodes 14 and 16 is appropriately determined according to a use or the like.

In FIG. 1, the X-axis, the Y-axis, and the Z-axis are perpendicular to each other, and the Z-axis corresponds to the lamination direction of the dielectric layers 25 and the internal electrode layers 30.

The shape or the size of the element body 20 is appropriately determined according to a purpose or a use. Preferred are a width W0 of 0.1 mm to 1.6 mm in the X-axis direction, a length L0 of 0.2 mm to 3.2 mm in the Y-axis direction, and a height H0 of 0.1 mm to 1.6 mm in the Z-axis direction.

### Method of Manufacturing Multilayer Ceramic Capacitor 10

A method of manufacturing the multilayer ceramic capacitor 10 as one embodiment of the present invention is specifically described next.

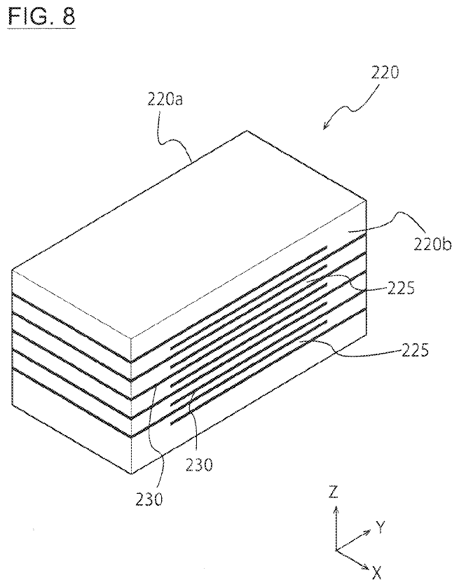

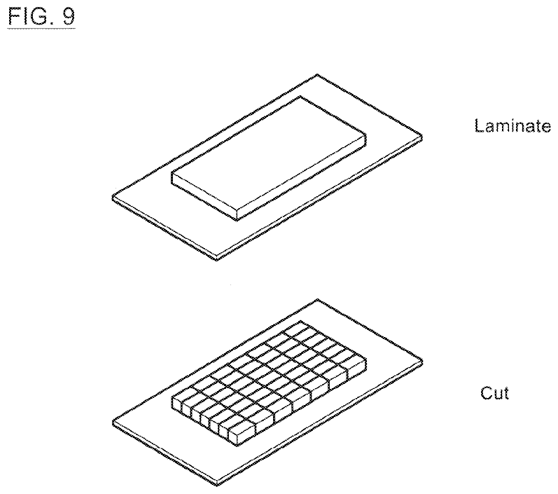

First, a green laminate 220 including alternately laminated dielectric green sheets 225 and internal electrode pattern layers 230 illustrated in FIG. 8 is prepared. The green laminate 220 illustrated in FIG. 8 is prepared by, as illustrated in FIG. 9, alternately laminating the dielectric green sheets 225, which become the dielectric layers 25 after firing, and the internal electrode pattern layers 230, which become the internal electrode layers 30 after firing, and then cutting the laminate into pieces.

The dielectric green sheets 225 used for preparation of the green laminate 220 are prepared using an organic solvent based paste that results from kneading a ceramic powder and an organic vehicle or using a water based paste. The internal electrode pattern layers 230 are prepared using an internal electrode layer paste that results from kneading a conductive material containing a conductive metal or alloy and an organic vehicle.

Note that, as illustrated in FIG. 8, at laminate side surfaces 220a and 220b of the green laminate 220, side edges of the internal electrode pattern layers 230 are exposed. The side edges constitute both ends of the internal electrode pattern layers 230 in the X-axis direction.

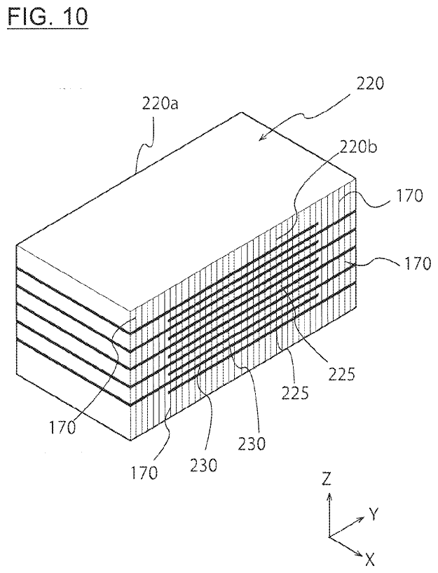

Then, the laminate side surfaces 220a and 220b, which include at least one cut surface of the green laminate 220 illustrated in FIG. 8 (in this embodiment, a pair of side surfaces), are irradiated with a laser for laser processing of side edge portions of the internal electrode pattern layers 230 included in the green laminate 220 (see FIG. 10).

As illustrated in FIG. 10, the laser processing is performed so that grooves (see FIG. 5 and the like) are formed at respective exposed portions, exposed to the laminate side surfaces 220a and 220b, of at least some of the internal electrode pattern layers 230 adjacent to each other in the lamination direction (Z-axis direction) and are aligned along the lamination direction. Specifically, as illustrated by vertical lines 170 in FIG. 10, the laminate side surfaces 220a and 220b are scanned and irradiated with a laser along the lamination direction to form the grooves 33b1, 33b2, 33b3, 33d1, and 33d3 illustrated in FIG. 5 and the like at both side edges of the internal electrode pattern layers 230 in the X-axis direction.

Then, to the laminate side surfaces 220a and 220b of the green laminate 220 after being laser processed as illustrated in FIG. 10, insulating material layers, which become the insulating layers 12 and 13 after firing, are formed (see FIG. 2). Methods of forming the insulating material layers on the laminate side surfaces 220a and 220b of the green laminate 220 include transfer or adhesion of sheet-like insulating material layers.

Then, the green laminate 220 with the insulating material layers on the laminate side surfaces 220a and 220b is solidified and fired to provide the element body 20 having the insulating layers 12 and 13 on the side surfaces 20a and 20b as illustrated in FIG. 2.

Finally, the end surfaces 20c and 20d of the element body 20 are provided with the external electrodes 14 and 16. This provides the multilayer ceramic capacitor 10 illustrated in FIG. 1 and the like. The external electrodes 14 and 16 are formed on the end surfaces 20c and 20d of the element body 20 through, for example, baking of a conductive material, electrolytic plating, or electroless plating.

As described above, the multilayer ceramic capacitor 10 illustrated in the embodiment has the grooves 33a, 33b, 33c, 33d, 33b1, 33b2, 33b3, 33d1, and 33d3 at the boundaries between the internal electrode layers 30 and the insulating layers 12 and 13 as illustrated in FIGS. 3 to 5; and the grooves 33b1, 33b2, 33b3, 33d1, and 33d3 of some of the internal electrode layers 30a and 30b adjacent to each other in the lamination direction are aligned along the lamination direction. This enables the internal electrode layers 30 and the insulating layers 12 and 13 to engage with each other at the boundaries, which are the lead-out portion side edges 32 and the overlapping portion side edges 35, to increase adhesion between the side surfaces 20a and 20b of the element body 20 and the insulating layers 12 and 13. This can prevent generation of pores between the insulating layers 12 and 13 and the element body 20 (laminate). Prevention of generation of pores between the insulating layers 12 and 13 and the side surfaces 20a and 20b of the element body 20 can prevent manufacturing defects and improve reliability.

### EXAMPLES

Hereinafter, the present disclosure is described based on further detailed examples. However, the present disclosure is not construed as limited to the following examples.

### Example 1

Using the method of manufacturing a multilayer ceramic capacitor 10 described in the description of the embodiment, one thousand multilayer ceramic capacitor samples according to Example 1 were manufactured under the following conditions. Using these samples, the porosity of electrode side edges at boundaries between insulating layers and electrodes, the insulating layers and the internal electrode layers, and IR measurement were evaluated.

Conditions of Example 1 were as follows.
Chip size: 0603-shaped chip
Capacitance (standard value): 1 μF
Presence/absence of grooves and their alignment: grooves are aligned along lamination direction
Average depth to bottoms of grooves: 0.1 μm

That the presence/absence of the grooves and their alignment and the depth to the bottoms of the grooves were as intended was confirmed by exposing each portion through polishing or the like and observing it with a laser microscope (VK-X1000 manufactured by KEYENCE CORPORATION). Table 1 shows sample conditions and evaluation results of Example 1, as well as other Examples and Comparative Examples.

TABLE 1

| | Sample conditions | | Evaluation results | | |
|---|---|---|---|---|---|
| | Presence/absence of | Average depth | Porosity of electrode | Joining state | IR |
| | grooves of intemal electrode | to bottoms | side edges at boundaries | between insulating | measurement |
| | layers and alignment along | of grooves | between insulating | layers and internal | after |
| | lamination direction | (μm) | layers and electrodes | electrode layers | plating (Ω) |
| Example 1 | Grooves are | 0.1 μm | 1% | Good | 1.00E+09 |
| | continuously aligned | | | | |
| | along lamination direction | | | | |
| Example 2 | Grooves are | 1.0 μm | 0% | Good | 1.00E+09 |
| | continuously aligned | | | | |
| | along lamination direction | | | | |
| Example 3 | Grooves are | 3.0 μm | 0% | Good | 1.00E-09 |
| | continuously aligned | | | | |
| | along lamination direction | | | | |
| Example 4 | Grooves are | 5.0 μm | 0% | Good | 1.00E+09 |
| | continuously aligned | | | | |
| | along lamination direction | | | | |
| Comparative | No grooves | 0.0 μm | Unmeasurable due | N/A due to | 1.00E+03 |
| Example 1 | | | to peeling-off | peeling-off | |
| Comparative | Chrooves are at random | 10.0 μm | 20% | Poor | 1.00E+05 |
| Example 2 | | | | | |

### Examples 2 to 4

Manufacture of samples and their evaluation were conducted as in Example 1 except that, among the sample conditions, the average depth to the bottoms of the grooves was changed to 1.0 μm, 3.0 μm, or 5.0 μm.

### Comparative Example 1

Manufacture of samples and their evaluation were conducted as in Example 1 except that, among the sample conditions, the average depth to the bottoms of the grooves was changed to 0 μm. Note that, in the manufacture of Comparative Example 1, the laser processing step on green laminates was omitted to form insulating material layers on laminate side surfaces 220a and 220b without grooves.

### Comparative Example 2

Manufacture of samples and their evaluation were conducted as in Example 1 except that, among the sample conditions, the grooves were not aligned along the lamination direction but were at random and the average depth to the bottoms of the grooves was changed to 10 μm.

In Examples 1 to 4, all samples had a low porosity (1.0% or less), good joining state between the insulating layers and the internal electrode layers, and good resistance between the electrodes, providing good evaluation results for all evaluation items. In particular, in Examples 2 to 4, a significant improvement in the joining state between the insulating layers and the internal electrode layers was observed, in comparison with Comparative Examples 1 and 2.

### REFERENCE NUMERALS

10, 110 . . . multilayer ceramic capacitor
20 . . . element body
20a, 20b . . . side surface
20c, 20d . . . end surface
30 . . . internal electrode layer
30a . . . first internal electrode layer
30b . . . second internal electrode layer
31 . . . internal electrode lead-out portion
32 . . . lead-out portion side edge
34 . . . internal electrode overlapping portion
35 . . . overlapping portion side edge
33a, 33b, 33c, 33d, 33b1, 33b2, 33b3, 33d1, 33d3 . . . groove
D . . . depth of groove
AVG . . . average depth of side edge
ST . . . standard line
25 . . . dielectric layer
26 . . . dielectric layer side edge
12, 13, 112, 113 . . . insulating layer
12b, 13b . . . insulating layer irregular portion
14, 16 . . . external electrode
112a, 113a . . . insulating layer main portion
112b, 113b . . . insulating layer filler portion
220 . . . green laminate
220a, 220b . . . laminate side surface
225 . . . dielectric green sheet
230 . . . internal electrode pattern layer
170 . . . vertical line

What is claimed is:

1. A multilayer electronic device comprising:
an element body comprising
an interior region comprising inner dielectric layers and internal electrode layers, the inner dielectric layers and the internal electrode layers being alternately laminated along a direction of a third axis and being substantially parallel to a plane containing a first axis and a second axis, and
exterior regions disposed at both sides outward from the interior region in the direction of the third axis;
insulating layers provided on respective side surfaces of the element body, the side surfaces facing each other in a direction of the first axis; and
external electrodes provided on respective end surfaces of the element body and electrically connected to the internal electrode layers, the end surfaces facing each other in a direction of the second axis,
wherein
the interior region comprises a central region and an end region in a predetermined section of the element body cut parallel to the first axis and the third axis;
the central region contains a center of the interior region in the direction of the third axis;
the end region contains an end of the interior region in the direction of the third axis;
distances between the internal electrode layers included in the central region and the insulating layers have a 1-μm variation at most in the predetermined section; and
at least one of the internal electrode layers included in the end region has a width along the direction of the first axis smaller by 1 μm or more than an average width of the internal electrode layers included in the central region, in the predetermined section.

2. The multilayer electronic device according to claim 1, wherein, in the predetermined section, the internal electrode layers included in the end region have a width, along the direction of the first axis, smaller by 0 to 20 μm than the average width of the internal electrode layers included in the central region.

3. The multilayer electronic device according to claim 1, wherein, in the predetermined section,
the internal electrode layers included in the end region comprise an outermost internal electrode layer and an end region internal electrode layer;
the internal electrode layers included in the central region comprise central region internal electrode layers;
the outermost internal electrode layer is closest to the end in the direction of the third axis;
the end region internal electrode layer is at a distance of 10% or less of an entire length of the element body in the direction of the third axis from the outermost internal electrode layer toward the center; and
the outermost internal electrode layer and the end region internal electrode layer have a width, along the direction of the first axis, smaller by 1 μm or more than an average width of the central region internal electrode layers.

4. The multilayer electronic device according to claim 1, wherein
the internal electrode layers included in the end region comprise electrode layer ends in the direction of the first axis; and
the multilayer electronic device further comprises a filler filling a space between the electrode layer ends and the insulating layers.

5. The multilayer electronic device according to claim 4, wherein 90% or more of a composition of the filler in mole percent matches a composition of the insulating layers or the inner dielectric layers.

6. The multilayer electronic device according to claim 4, wherein 20% or more of a composition of the filler in mole percent differs from a composition of the insulating layers or the inner dielectric layers.

7. The multilayer electronic device according to claim 4, wherein
the filler comprises at least one selected from the group consisting of Mg, Si, and Mn; and
a content of the at least one selected from the group consisting of Mg, Si, and Mn is higher by 0.01 to 3 mol % than that of the inner dielectric layers.

8. The multilayer electronic device according to claim 4, wherein
the filler comprises at least one selected from the group consisting of Mg, Si, and Mn; and
the filler comprises an oxide of a metal identical to a metal contained in the internal electrode layers.

9. A method of manufacturing a multilayer electronic device, comprising:
laminating and then cutting inner dielectric green sheets and internal electrode pattern layers between exterior body green sheets in pairs to provide a green laminate comprising a green interior region where the inner dielectric green sheets and the internal electrode pattern layers are alternately laminated between green exterior regions defined by the exterior body green sheets in pairs;
irradiating a laminate side surface of the green laminate with a laser for laser processing of the green interior region, the laminate side surface comprising at least one cut surface of the green laminate; and
firing the green laminate after the laser processing,
wherein
the laser processing of the green interior region is performed so that the internal electrode pattern layers included in an end region of the green interior region are smaller along a normal direction of the laminate side surface than the internal electrode pattern layers included in a central region of the green interior region,
the end region contains an end of the green interior region in the lamination direction, and
the central region contains a center of the green interior region in the lamination direction.
